(19) United States
(12) Patent Application Publication
(10) Pub. No.: US 2004/0142193 A1
(43) Pub. Date: Jul. 22, 2004

(54) Pressure-sensitively adhesive mouldings

(75) Inventors: Marc Husemann, Hamburg (DE); Thilo Dollase, Hamburg (DE)

Correspondence Address: Norris, McLaughlin & Marcus P.A., 220 East 42nd Street, 30th Floor, New York, NY, 10017, US

(73) Assignee: tesa Aktiengesellschaft, Hamburg (DE)

(21) Appl. No.: 10/687,494

(22) Filed: Oct. 16, 2003

(30) Foreign Application Priority Data
Oct. 17, 2002 (DE) 102 48 380.9

(51) Int. Cl. B32B 27/00

(52) U.S. Cl. 428/500

(57) ABSTRACT

Moulding composed of one or more block copolymers based on polyacrylate or mixtures comprising such block copolymers, characterized by inherent pressure-sensitive adhesion properties.

The invention relates to mouldings based on block copolymers, to the production of such mouldings and to their use.

### BACKGROUND OF THE INVENTION

Pressure-sensitive adhesive tapes are a long-known, very widespread product. Formerly pressure-sensitive adhesives for such tapes were prepared from solution or from dispersion. To raise the efficiency of the production operation, hotmelt processes are increasingly being employed, since with these processes there is no need for solvent during the coating operation.

The plastics-processing industry likewise processes a multiplicity of thermoplastics from the melt and in that way produces mouldings for a very wide variety of applications. One very commonplace method of producing complex mouldings is the injection-moulding process. Employed additionally are a variety of other injection processes and winding processes. Melting is very often carried out using extruders which melt the thermoplastics, convey them and press them, for example, under great pressure through a die into a mould. In addition to the abovementioned processes, thermoplastics are also compressed in moulds or machined subsequently, using mills or lathes for example.

The mouldings produced in the plastics industry are used very diversely for a very wide variety of purposes, in particular as structural components, but these components are not pressure-sensitively adhesive.

For certain applications it can be of advantage if such mouldings possess their own pressure-sensitive adhesion and so facilitate processing. This is true particularly of sealing materials, which ought to possess a certain flexibility and for the processing operation, for fixing, ought to possess a slight pressure-sensitive adhesion.

It is very difficult to produce such mouldings from conventional materials, for example from polyacrylate compounds, in accordance with the prior art, since, among others, crosslinking methods such as UV curing or EB curing are impracticable owing to the complex structures and the high layer thicknesses of the mouldings.

It is an object of the invention to provide mouldings for different fields of use which in addition to the physical properties required for the purpose (for example elasticity, adequate intrinsic stability, etc) have their own pressure-sensitive adhesion.

### SUMMARY OF THE INVENTION

This object is surprisingly achieved through the use of pressure-sensitive adhesives based on polyacrylate block copolymer. The invention accordingly provides mouldings composed of one or more polyacrylate-based block copolymers or mixtures comprising such block copolymers, characterized by pressure-sensitive adhesion properties.

### DETAILED DESCRIPTION

In one preferred embodiment of the moulding of the invention the block copolymers have a sequence of “hard” polymer blocks P_{H} having a low glass transition temperature and “soft” polymer blocks P_{S} having a high glass transition temperature, very advantageously a sequence of at least one polymer block or copolymer block P_{H} having a glass transition temperature of not more than 10° C. and of at least one polymer block or copolymer block P_{S} having a glass transition temperature of at least 20° C.

The term “polymer block” here and below is intended to embrace not only polymer blocks of only one variety of monomer but also copolymer blocks of two or more monomers.

In one further advantageous embodiment of the invention the block copolymers comprise at least one triblock structure of the form P_{S}-P_{H}-P_{S} and/or of the form P_{H}-P_{S}-P_{H}.

In accordance with the invention the mouldings are composed in particular of block copolymers in which the polymer blocks P_{H} are of the kind P(A) and the polymer blocks P_{S} are of the kind P(B). P(A) here represents a polymer block of one or more monomers of a monomer group A and P(B) here represents a polymer block of one or more monomers of a monomer group B.

For a first preferred embodiment of the invention the block copolymers may also comprise copolymer blocks of the form P(ANC) (in the sense of P_{H}) and/or P(B/D) (in the sense of P_{S}), it being possible for the polymer blocks P(A) and/or P(B) of the aforesaid block copolymers to have been substituted in whole or in part by the polymer blocks P(A/C) and P(B/D) respectively. The expression P(A/C) refers here to copolymer blocks of monomers of monomer group A and a monomer group C; correspondingly, P(B/D) represents a copolymer block of monomers of monomer group B and of a monomer group D.

It is further of advantage if some of the block copolymers P_{S} and/or P_{H}, or all block copolymers P_{S} and/or P_{H}, comprise at least one functional group which behaves inertly in a free-radical polymerization reaction and which is capable of promoting a crosslinking reaction of the polymers.

It is of advantage for the inventive mouldings, particularly in the form of the embodiments set out in this text, if at least one block copolymer has a symmetrical construction such that there are polymer blocks P_{S} identical in chain length and/or chemical structure and/or polymer blocks P_{H} identical in chain length and/or chemical structure.

With particular preference the polyacrylate pressure-sensitive adhesives used have different stress/strain characteristics in the lengthwise and transverse directions.

It is advantageous if at least one block copolymer, preferably two or more or all of the block copolymers, meets one or more of the following criteria:

number average molecular weight Mₙ of between 25,000 and 600,000 g/mol, preferably between 30,000 and 400,000 g/mol, more preferably between 50,000 and 300,000 g/mol,

a polydispersity D=M_{w}/Mₙ of not more than 3,

a hard polymer block P_{H} fraction of between 5 and 49% by weight, preferably between 7.5 and 35% by weight, in particular between 10 and 30% by weight, based on the sum of hard polymer blocks P_{H} and soft polymer blocks P_{S},

one or more grafted-on side chains.

In particular the ratio of the chain lengths of the polymer blocks P_{H} to those of the polymer blocks P_{S} can be chosen such that the polymer blocks P_{H} are present in the form of a disperse phase (“domains”) in a continuous matrix of the polymer blocks P_{S}, in particular as spherical or distortedly spherical or cylindrical domains.

Some advantageous embodiments which can be used with particular advantage according to the invention are set out by way of example below.

Pressure-sensitive adhesives which can be used outstandingly for the mouldings of the invention include, for example, those pressure-sensitive adhesives based on block copolymers of the general type P(B)-P(A/C)-P(B), in which each block copolymer is composed of a middle copolymer block P(A/C) and two end polymer blocks P(B), where

P(A/C) represents a copolymer of monomers of monomer groups A and C, with P(A/C) possessing a glass transition temperature of from 10° C. to −80° C., at least some of the monomers of monomer group C possessing at least one functional group which behaves inertly in a free-radical polymerization reaction, and which serves to enhance the cohesion of the block copolymer,

P(B) represents a polymer of monomers of monomer group B, with P(B) possessing a glass transition temperature of from 20° C. to 175° C.,

the polymer block P(B) is insoluble in the copolymer block P(A/C), and the blocks P(B) and P(A/C) are immiscible.

The cohesion-enhancing effect of the copolymer P(A/C) may advantageously be brought about by bonds between the individual block copolymers P(B)-P(A/C)-P(B), with at least one functional group of the monomers of monomer group C of one block copolymer macromolecule entering into interaction with at least one further block copolymer macromolecule. With particular advantage the functional group of the (copolymerized) monomers of monomer group C induces the enhancement in cohesion by means of dipole-dipole interactions and/or hydrogen bonding. With particular preference the functional group of the monomers of monomer group C is a carboxylic acid group, a hydroxyl group or a tert-butyl group. With further particular preference the monomer of monomer group C used comprises at least one of the following compounds: acrylic acid, hydroxyethyl acrylate, hydroxypropyl acrylate, methacrylic acid, methyl methacrylate, hydroxyethyl methacrylate, hydroxypropyl methacrylate, tert-butyl acrylate, itaconic anhydride, itaconic acid, acrylamide, such as N-tert-butylacrylamide, N-isopropylacrylamide or dimethylacrylamide, for example, and maleic anhydride. With advantage the crosslinking-capable functional group of the monomers of monomer group C can be an unsaturated group which is capable of radiation-chemical crosslinking, in particular through crosslinking which is brought about by UV irradiation or by bombardment with electron beams. It has proven to be advantageous if the crosslinking-capable functional group of the monomers of the monomer group C is an unsaturated alkyl radical having 3 to 8 carbon atoms which has at least one C—C double bond. With further particular preference the crosslinking-capable functional group of the monomers of monomer group C is a functional group which is made capable of crosslinking reaction though the influence of thermal energy. The functional group of the monomers of monomer group C is chosen advantageously as a hydroxyl, carboxyl, epoxy, acid amide, isocyanato or amino group.

Monomers of monomer group C which can be used advantageously include at least one compound of the following general formula

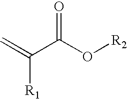

where R₁=H or CH₃ and —OR₂ constitutes or comprises the functional group referred to above. The monomers of monomer group C can be chosen such that they lower the glass transition temperature of the copolymer block P(A/C) to T_{G}<10° C.

As monomers of monomer group A it is preferred to use at least one compound of the following general formula

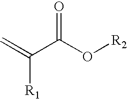

where R₁=H or CH₃ and R₂ comes from the group of branched or unbranched saturated alkyl groups having 4-14 carbon atoms.

The monomers of monomer group B are preferably selected such that the resultant polymer blocks P(B) are capable of forming a 2-phase domain structure with the copolymer blocks P(A/C). The fraction of the polymer blocks P(B) is very preferably between 10 and 60% by weight, in particular between 15 and 40% by weight of the overall block copolymer.

Further, the weight fraction of monomers of monomer group C in proportion to monomers of monomer group A is advantageously between 0.1 and 20, in particular between 0.5 and 5.

Another pressure-sensitive adhesive which can be used outstandingly for the purposes of the invention is based on block copolymers of the general type P(A)-P(B)-P(A) or of the type P(A/C)-P(B)-P(A/C), each block copolymer being composed of a middle (co)polymer block P(B) and two end (co)polymer blocks P(A) or P(A/C) respectively, where

P(A) represents a (co)polymer block of at least one monomer of monomer group A, with P(A) possessing a glass transition temperature of 10° C. or less, or P(A/C) represents a copolymer block of monomers of monomer groups A and C, with P(A/C) possessing a glass transition temperature of 10° C. or less, at least some of the monomers of monomer group C possessing at least one functional group which behaves inertly in a free-radical polymerization reaction and which serves to enhance the cohesion of the block copolymer,

P(B) represents a (co)polymer block of at least one monomer of monomer group B, with P(B) possessing a glass transition temperature of 20° C. or more,

the (co)polymer block P(B) is insoluble in the (co)polymer block P(A) or P(ANC), respectively, the blocks P(B) and P(A) being immiscible.

Preferably at least some of the monomers of monomer group C include at least one functional group which behaves inertly in a free-radical polymerization reaction and which serves to increase the cohesion of the block copolymer; in particular through bonds between the individual block copolymers, with at least one functional group of the (copolymerized) monomers of monomer group C of one block copolymer macromolecule entering into interaction with at least one further block copolymer macromolecule; in particular through a crosslinking reaction. The functional group for increasing the cohesion can with very great advantage be a hydroxyl, carboxyl, epoxy, acid amide, isocyanate or amino group, a group comprising a photoinitiator for UV crosslinking, or an unsaturated group.

With further advantage the block P(A) and/or P(A/C) possesses a glass transition temperature of between −80° C. and 10° C. and/or the block P(B) possesses a glass transition temperature of between 25° C. and 180° C.

The fraction of the (co)polymer blocks P(B) is preferably between 10 and 60% by weight, in particular between 15 and 40% by weight, of the overall block copolymer.

The weight fraction of the monomers of monomer group C in relation to the monomers of monomer group A is advantageously between 0.1 and 20, in particular between 0.5 and 10.

A further pressure-sensitive adhesive which can be used with advantage in accordance with the invention is one based on block copolymers of the general type P(B/D)-P(A)-P(B/D), each block copolymer being composed of a middle copolymer block P(A) and two end polymer blocks P(B/D), where

P(A) represents a polymer block of one or more monomers of monomer group A, with P(A) possessing a glass transition temperature of below 10° C., in particular from 10° C. to −80° C.,

P(B/D) represents a polymer of at least one each of monomers of monomer groups B and D, with the block P(B/D) possessing a glass transition temperature of from 20° C. to 175° C., at least some of the monomers of monomer group D comprising at least one functional group capable of crosslinking,

the polymer block P(A) is insoluble in the copolymer block P(B/D), and the blocks P(A) and P(B/D) are immiscible.

In this case the crosslinking-capable functional group of the monomers of monomer group D is advantageously an unsaturated group which is capable of radiation-chemical crosslinking, in particular of a crosslinking which is brought about through UV irradiation or through bombardment with electron beams. This may preferably be an unsaturated alkyl radical which has at least one C—C double bond. The crosslinking-capable functional group of monomers of monomer group D may with further advantage be a group which is capable of a crosslinking reaction through the influence of thermal energy. The functional group of the monomers of monomer group D which is chosen can with advantage be a hydroxyl, carboxyl, epoxy, acid amide, isocyanate or amino group.

In an advantageous procedure the monomers of monomer group D that are used comprise at least one compound which raises the glass transition temperature of the copolymer block P(B/D) to T_{G}>20° C.

As monomers of monomer groups B and D it is preferred to chose monomers which render the block P(B/D) capable of forming a 2-phase domain structure with the copolymer block P(A), it also being possible for the monomers of monomer groups B and D to be identical.

With advantage the fraction of the polymers blocks P(B/D) is between 10 and 60% by weight, in particular between 15 and 40% by weight, of the overall block copolymer. With further advantage the weight fraction of monomers of monomer group D in relation to monomers of monomer group B is between 0.1 and 20, in particular between 0.5 and 5.

Oriented acrylate block copolymers can also be used with advantage in accordance with the invention. In this case it is possible, for example, to use a pressure-sensitive adhesive based on at least one block copolymer, with the weight fractions of the block copolymers totalling at least 50% of the pressure-sensitive adhesive, and at least one block copolymer being composed at least in part on the basis of (meth)acrylate acid derivatives, with, additionally, at least one block copolymer containing at least the unit P(B)-P(A)-P(B) comprising at least one polymer block P(B) and at least two polymer blocks P(A), where

P(B) independently of one another represent homopolymer or copolymer blocks of monomers of monomer group B, the polymer blocks P(B) each having a softening temperature in the range from +20° C. to +175° C.,

P(A) represents a homopolymer or copolymer block of monomers of monomer group A, the polymer block P(A) having a softening temperature in the range from −130° C. to +10° C.,

the polymer blocks P(B) and P(A) are not homogenously immiscible with one another, and

the pressure-sensitive adhesive system is oriented in that it possesses a preferential direction, the refractive index measured in the preferential direction, n_{MD}, being greater than the refractive index n_{CD} measured in a direction perpendicular to the preferential direction.

With particular preference the difference Δn=n_{MD}−n_{CD} amounts to at least 1·10⁻⁵. With further advantage the pressure-sensitive adhesive exhibits a shrinkback of at least 5%, measured as follows:

The pressure-sensitive adhesive was coated from the melt through a die onto a siliconized release paper. Strips at least 30 mm wide and 20 cm long were cut parallel to the coating direction of the hotmelt. At application rates of 130 g/m², 3 strips, and at 50 g/m² 8 strips, were laminated together in order to give comparable layer thicknesses. The specimen obtained in this way was then cut to a width of 20 mm exactly, and strips of paper were stuck over it at each end with a spacing of 15 cm. The test specimen thus prepared was then suspended vertically at RT and the change in length was monitored over time until no further shrinkage of the sample could be ascertained. The initial length, reduced by the final value, was then expressed as the shrinkback, in per cent based on the initial length.

The structure of at least one block copolymer can be described advantageously by means of one or more of the following general formulae:

P(B)-P(A)-P(B) (I)

P(A)-P(B)-P(A)-P(B)-P(A) (II)

[P(A)-P(B)]ₙX (III)

[P(A)-P(B)]ₙX[P(B)]ₘ (IV)

where n=3 to 12, m=3 to 12 and X represents a multifunctional branching region,

where the polymer blocks P(B) independently of one another represent homopolymer or copolymer blocks of monomers of monomer group B, with the polymer blocks P(B) each having a softening temperature in the range from +20° C. to +175° C.,

and where the polymer blocks P(A) independently of one another represent homopolymer or copolymer blocks of monomers of monomer group A, with the polymer blocks P(A) each having a softening temperature in the range from -1 30° C to +10° C.

It is additionally possible with advantage to use blends of polyacrylate-based block copolymers.

Thus it is possible to make outstanding use of a polymer blend of two or more block copolymers corresponding to the details above, and also of a blend of one or more block copolymers corresponding to the details above with at least one diblock copolymer P(B)-P(A),

where the polymer blocks P(B) independently of one another represent homopolymer or copolymer blocks of monomers of monomer group B, with the polymer blocks P(B) each having a softening temperature in the range from +20° C. to +175° C.,

and where the polymer blocks P(A) independently of one another represent homopolymer or copolymer blocks of monomers of monomer group A, with the polymer blocks P(A) each having a softening temperature in the range from −130° C. to +10° C.,

and/or with at least one polymer P′(B) and/or P′(A),

where the polymers P′(B) represent homopolymers and/or copolymers of monomers of monomer group B, with the polymers P′(B) each having a softening temperature in the range from +20° C. to +175° C.,

where the polymers P′(A) represent homopolymers and/or copolymers of monomers of monomer group A, with the polymers P′(A) each having a softening temperature in the range from −130° C. to +10° C.

A further possibility for use, outstandingly, in accordance with the concept of the invention is a blend of at least two components K1 and K2, each component being based on at least one block copolymer P1 or P2 respectively,

where the at least one block copolymer P1 of component K1 comprises at least the unit P(B1)-P(A1)-P(B1) comprising at least one polymer block P(A1) (in the sense of P_{H}) and at least two polymer blocks P(B1) (in the sense of P_{S}), with

P(B1) independently of one another representing homopolymer or copolymer blocks of monomers of monomer group B, with the polymer blocks P(B1) each having a softening temperature in the range from +20° C. to +175° C.,

P(A1) represents a homopolymer or copolymer block of monomers of monomer group A, with the polymer block P(A1) having a softening temperature in the range from −130° C. to +10° C.,

the polymer blocks P(B1) and P(A1) are not homogeneously miscible with one another,

with the at least one block copolymer P2 of component K2 comprising at least the unit P(A2)-P(B2)-P(A2) comprising at least two polymer blocks P(A2) (in the sense of P_{H}) and at least one polymer block P(B2) (in the sense of P_{S}), and with

P(B2) representing a homopolymer or copolymer block of monomers of monomer group B, with the polymer block P(B2) having a softening temperature in the range from +20° C. to +175° C.,

P(A2) independently of one another representing homopolymer or copolymer blocks of monomers of monomer group A, with the polymer blocks P(A2) each having a softening temperature in the range from −130° C. to +10° C.,

the polymer blocks P(B2) and P(A2) are not homogeneously miscible with one another,

and where the blend forms an at least two-phase system.

With advantage the ratio V of the amount m_{K2} of component K2 used in the blend to the amount m_{K1} of the component K1 used in the blend is up to 250 parts by weight of K2 to 100 parts by weight of K1, i.e. V=m_{K2}/m_{K1} 2.5.

The blocks P(B1) are preferably compatible with the blocks P(B2) and/or their corresponding polymers P′(B1) are compatible in each case with P′(B2) and/or the blocks P(A1) are compatible with the blocks P(A2) and/or their corresponding polymers P′(A1) are compatible in each case with P′(A2).

With further advantage the polymer blocks P(B1) and the polymer blocks P(B2) and/or the polymer blocks P(A1) and the polymer blocks P(A2) possess an identical homopolymer and/or copolymer composition.

It is advantageous if the average chain length LA2 of the polymer blocks P(A2) of the block copolymer P2 does not exceed the average chain length LA1 of the polymer block P(A1) of the block copolymer P1, with LA2 being advantageously at least 10% less than LA1, and with LA2 being very advantageously at least 20% less than LA1.

It is further of advantage if the polymer blocks P(Bi) (i=1, 2, . . . ) are present as a disperse phase (“domains”) in a continuous matrix of the polymer blocks P(Ai), preferably as spherical or distortedly spherical domains, this state being attained in particular by adjusting the ratio V_{Li} of the average chain lengths LBi of the polymer blocks P(Bi) to the average chain lengths LAi of the polymer blocks P(Ai) of the block copolymers Pi, very preferably by adjusting the ratio V_{L1} of the block copolymer P1.

In addition to the particularly suitable pressure-sensitive adhesives above mention may also be made of those which have star structures, corresponding for instance to

[P_{H}-P_{S}]ₙX

[P_{S}-P_{H}]ₙX

[P_{S}-P_{H}-P_{S}]ₙX

[P_{H}-P_{S}-P_{H}]ₙX

or, generally,

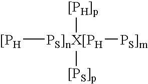

where m, n, p, q independently of one another=0, 1, 2, 3 . . . and X represents a polyfunctional branching unit, i.e. a chemical structural element via which two or more polymer arms are linked to one another.

In this context it is also possible for there to be two or more branching units in the polymers. Monomers A used to advantage for the copolymer blocks P(A), P(Ai) and/or P(ANC) of the pressure-sensitively adhesive mouldings used in accordance with the invention are acrylic monomers or vinyl monomers, more preferably those which lower the glass transition temperature of the copolymer block P(A/C)—including in combination with monomer C—to below 10° C., very preferably below 0° C.

Very advantageously for the pressure-sensitively adhesive mouldings of the invention use is made as monomers of monomer group A of one or more compounds which can be described by the following general formula:

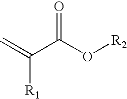

In this formula R₁═H or CH₃ and the radical R₂ is chosen from the group of branched or unbranched saturated alkyl groups having 4 to 14 carbon atoms.

Acryl monomers which are used with preference for the inventive pressure-sensitively adhesive mouldings as monomers of monomer group A embrace acrylic and methacrylic esters with alcohol groups consisting of 4 to 14 carbon atoms, preferably 4 to 9 carbon atoms. Specific examples, without wishing to be restrictive by this enumeration, are n-butyl acrylate, n-pentyl acrylate, n-hexyl acrylate, n-heptyl acrylate, n-octyl acrylate, n-nonyl acrylate and the branched isomers thereof, such as 2-ethylhexyl acrylate. Furthermore, optionally, vinyl monomers from the following groups are used as monomers of monomer group A:

vinyl esters, vinyl ethers, vinyl halides, vinylidene halides, vinyl compounds with aromatic rings and heterocycles in α-position.

Here again mention may be made, non-exclusively, of some examples: vinyl acetate, vinylformamide, vinylpyridine, ethyl vinyl ether, vinyl chloride, vinylidene chloride, acrylonitrile.

The monomers of monomer group B for the copolymer blocks P(B), P(Bi) and/or P(B/D) of the pressure-sensitively adhesive mouldings of the invention are preferably chosen such that the resulting blocks P(B), P(Bi) and/or P(B/D) are capable of forming a 2-phase domain structure with the copolymer blocks P(A), P(Ai) and/or P(A/C). A prerequisite for this is the immiscibility of the blocks P(B), P(Bi) and P(B/D) with the blocks P(A), P(Ai) and P(A/C) respectively. Within the 2-phase domain structure, regions are formed in which the blocks of different (and, where appropriate, also identical) chains of one and the same variety of monomer mix with one another. These domains, as they are called, are embedded in a matrix of the blocks of the other variety of monomer. A characteristic possessed by such a 2-phase domain structure is two glass transition temperatures. With the formation of two phases of different properties, hard segments are obtained alongside soft segments.

Advantageous examples of compounds which are used as monomers of monomer group B are vinyl aromatics, methyl methacrylates, cyclohexyl methacrylates and isobornyl methacrylates. Particularly preferred examples of such monomers are methyl methacrylate and styrene.

As monomers of monomer group C it is preferred to use acrylic monomers or vinyl monomers which lower the glass transition temperature of the copolymer block P(A/C)—including in combination with monomers of monomer group A—to below 0° C. In one advantageous version of the process of the invention acrylic monomers are used, particularly those corresponding to the following general formula:

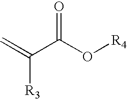

where R₃═H or CH₃ and the radical —OR₄ represents or comprises the functional group for raising the internal strength of the pressure-sensitively adhesive moulding.

Examples of monomers of monomer group C are hydroxyethyl acrylate, hydroxypropyl acrylate, hydroxyethyl methacrylate, hydroxypropyl methacrylate, acrylic acid, methacrylic acid, methyl methacrylate, t-butyl acrylate, alkyl alcohol, maleic anhydride, itaconic anhydride, itaconic acid, benzoin acrylate, acrylated benzophenone, acrylamides (such as, for example, N-t-butylacrylamide, N-isopropylacrylamide, dimethylacrylamide) and glyceridyl methacrylate, this enumeration not being exhaustive.

Preferably chosen in this context are:

a) for dipole-dipole interaction-forming and/or hydrogen bond-forming properties:

acrylic acid, methacrylic acid, itaconic acid, and also hydroxyethyl acetate, hydroxypropyl acetate, allyl alcohol, acrylamides, hydroxyethyl methacrylate, methyl methacrylate

b) for crosslinking with high-energy radiation:

benzoic acrylate, acrylated benzophenone

c) for thermal crosslinking:

hydroxyethyl acrylate, hydroxypropyl acrylate, hydroxyethyl methacrylate, hydroxypropyl methacrylate, acrylic acid, methacrylic acid, allyl alcohol, maleic anhydride, itaconic anhydride, itaconic acid, glyceridyl methacrylate, but also all acrylamides.

With t-butyl acrylate and, for example, stearyl acrylate an additional increase is brought about in the glass transition temperature. The polymers resulting from this have a higher molecular weight and a restricted mobility.

As monomers of monomer group D it is preferred to use acrylic monomers or vinyl monomers which raise the glass transition temperature of the copolymer block P(A/C)—including in combination with monomers of monomer group B—to more than 20° C.

Particularly preferred examples of monomers of monomer group D are acrylated photoinitiators, such as benzoin acrylate or acrylated benzophenone, for example, hydroxyethyl methacrylate, hydroxypropyl methacrylate, acrylic acid, methacrylic acid, allyl alcohol, maleic anhydride, itaconic anhydride, itaconic acid, acrylamide and glyceridyl methacrylate, this enumeration not being exhaustive.

The polymerization can be carried out in accordance with a process known per se or a modification of a process known per se, in particular by conventional free-radical polymerization and/or by controlled-growth free-radical polymerization; the latter is characterized by the presence of suitable control reagents.

With further advantage it is possible to admix resins to the pressure-sensitively adhesive mouldings. As tackifying resins to be added it is possible without exception to use all tackifer resins which are already known and are described in the literature. Representatives that may be mentioned include pinene resins, indene resins and rosins, their disproportionated, hydrogenated, polymerized and esterified derivatives and salts, the aliphatic and aromatic hydrocarbon resins, terpene resins and terpene-phenolic resins, and also C5, C9 and other hydrocarbon resins. Any desired combinations of these and further resins may be used in order to adjust the properties of the resultant adhesive in accordance with what is desired. Generally speaking it is possible to use any (soluble) resins which are compatible with the corresponding polyacrylate; reference may be made in particular to all aliphatic, aromatic and alkyl aromatic hydrocarbon resins, hydrocarbon resins based on single monomers, hydrogenated hydrocarbon resins, functional hydrocarbon resins, and natural resins. Express reference is made to the depiction of the state of the art in the “Handbook of Pressure Sensitive Adhesive Technology” by Donatas Satas (van Nostrand, 1989).

In a further advantageous development, one or more plasticizers, such as low molecular mass polyacrylates, phthalates, whale oil plasticizers or plasticizer resins, are added to the polyacrylates.

The polyacrylates may further be blended with one or more additives such as aging inhibitors, light stabilizers, ozone protectants, fatty acids, resins, nucleators, expandants, compounding agents and/or accelerants.

The pressure-sensitively adhesive mouldings may also be admixed with one or more fillers such as fibres, carbon black, zinc oxide, titanium dioxide, colour pigments, solid or hollow glass (micro)beads, microbeads of other materials, silica, silicates and chalk, the addition of blocking-free isocyanates also being possible.

The pressure-sensitively adhesive polymer is advantageously processed further from the melt. If the polymer has not been prepared in bulk, in one preferred configuration the polymerization solvent is stripped off under reduced pressure in, for example, a concentrating extruder. By way of example single-screw or twin-screw extruders can be used, which preferably distil off the solvent in different or the same vacuum stages and possess a feed preheater.

From the pressure-sensitively adhesive polymer the mouldings of the invention are produced. Three-dimensional pressure-sensitively adhesive mouldings can be manufactured outstandingly here, with virtually any shapes and dimensions being selectable.

In one very preferred process the polymer is processed by injection moulding. The shape is determined by the respective master. The pressure-sensitively adhesive mouldings can therefore be manufactured as solid masses or with a hollow interior. Through the form of the master it is possible for the pressure-sensitively adhesive mouldings to take on virtually any shape. It is possible, for example, to obtain round, angular or oval mouldings. In one preferred configuration the shape-imparting master is furnished with a release layer/release coating which facilitates the removal of the pressure-sensitively adhesive moulding from the master.

In one further embodiment the pressure-sensitive adhesives can also be equipped with lubricants or adhesion-reducing substances which facilitate processing.

Another process for producing the pressure-sensitively adhesive mouldings comprises the compression of mouldings. In this case the blank is compressed to the desired shape under high pressure and temperatures. For this production process as well the compression mould is preferably furnished with a release coating or release layer so that the pressure-sensitively adhesive mouldings can be removed much more easily from the mould.

In a further implementation the pressure-sensitively adhesive mouldings can be produced by blow mouldings. In this way it is particularly preferred to produce hollow mouldings. Furthermore, pressure-sensitively adhesive mouldings can also be produced by a diecutting operation. In this operation as well the die determines the shape of the pressure-sensitively adhesive mouldings.

One further possibility for producing pressure-sensitively adhesive mouldings is the roto-moulding process.

It is also possible with advantage to produce foamed pressure-sensitively adhesive mouldings. Foaming can be achieved very preferably, for example, by addition of a propellant gas. It is also possible to melt the polymer in an extruder and press through a die. By introducing inert gas, such as nitrogen gas, it is also possible to produce foamed mouldings by this method. A variety of pressure-sensitively adhesive mouldings can be produced here in turn by means of different dies.

With a view to specific areas of application of the pressure-sensitively adhesive mouldings it may be of advantage if one or more stabilizing films are present in the pressure-sensitively adhesive mouldings. For stabilization it is also possible, optionally, for stabilizing fibres or fillers to be present.

It can be of advantage to fix the mouldings on special supports. Of particular suitability are paper, fabric or films with a release effect. Such a release effect can be achieved, for example, through a coating with polysiloxanes or with fluorinated polymer/oligomers.

In accordance with the invention it is very advantageous if the mouldings have a sufficiently high pressure-sensitive adhesion in order to hold their own weight for at least 30 minutes on at least one material selected from polyethylene, ABS (acrylonitrile-butadiene-styrene copolymers) and/or polystyrene when having been pressed onto a test area of said material with an application pressure of 19.6 N/cm².

The invention further provides for the use of the pressure-sensitively adhesive mouldings for single-sided or double-sided adhesion bonding of substrates, as sealing material or as structural components, particularly in the automotive industry.

An example of one application is that of (especially three-dimensional) sticky pads, for fixing slips of paper temporarily to different substrates or different substrates to one another.

For sealing, preference is given to pressure-sensitively adhesive mouldings which possess a high elastic component. In this case as well fixing has been made easier by virtue of the pressure-sensitive adhesion.

The invention is illustrated below by a number of examples, without wishing to be unnecessarily restricted thereby.

### EXAMPLES

Test Methods:

A. Gel Permeation Chromatography (GPC)

The average molecular weight M_{N} and M_{N} and the polydispersity PD were determined by gel permeation chromatography. The eluent used was THF containing 0.1% by volume trifluoroacetic acid. Measurement took place at 25° C. The precolumn used was PSS-SDV, 5μ, 10³ Å, ID 8.0 mm×50 mm. Separation was carried out using the columns PSS-SDV, 5μ, 10³ and also 10⁵ and 10⁶ each with ID 8.0 mm×300 mm. The sample concentration was 4 g/l, the flow rate 1.0 ml pro minute. The measurement was carried out against polystyrene standards.

B. Pressure-Sensitive Adhesion

To determine the pressure-sensitive adhesion the individual examples were pressed onto PE, ABS and polystyrene plates (application pressure in each case 19.6 N/cm²) and these pates were set up vertically.

The exemplary samples described possessed a sufficiently high bond strength to hold their own weight for at least 30 minutes.

Preparation of a RAFT Regulator:

The regulator bis-2,2′-phenylethyl trithiocarbonate was prepared starting from 2-phenylethyl bromide with carbon disulfide and sodium hydroxide in accordance with a specification from Synth. Comm., 1988, 18 (13), 1531. Yield: 72%. ¹H-NMR (CDCl₃), δ: 7.20-7.40 ppm (m, 10 H); 3.81 ppm (m, 1 H); 3.71 ppm (m, 1 H); 1.59 ppm (d, 3 H); 1.53 ppm (d, 3 H).

Preparation of Polystyrene (PS):

A 2 l reactor conventional for free-radical polymerization was charged under a nitrogen atmosphere with 362 g of styrene and 3.64 g of bis-2,2′-phenylethyl trithiocarbonate regulator. This initial charge was heated to an internal temperature of 110° C. and initiation was carried out with 0.15 g of Vazo 67® (DuPont). After a reaction time of 10 hours, 100 g of toluene were added. After a reaction time of 24 hours, initiation was carried out with a further 0.1 g of Vazo 67® and polymerization was carried out for a further 24 hours.

During the polymerization there was a marked increase in viscosity. This was compensated by adding 150 g of toluene as final dilution after 48 hours.

For purification the polymer was precipitated from 4.5 litres of methanol, filtered off on a frit and subsequently dried in a vacuum drying cabinet.

Gel permeation chromatography (Test A) against polystyrene standards gave Mₙ=29 300 g/mol and M_{W}=35 500 g/mol.

### Example 1

In a second step, 59 g of polystyrene PS were mixed, in a reactor conventional for free-radical polymerizations, with 94.1 g of stearyl acrylate, 174.7 g of 2-ethylhexyl acrylate and 100 g of acetone/special-boiling-point spirit 60/95 (1:1). After half an hour of inertization under nitrogen gas, the mixture was heated to an internal temperature of 60° C. and initiation was carried out with 0.15 g of Vazo 67® (free radical initiator) (DuPont) in solution in 5 g of acetone. After a reaction time of 1.5 hours initiation was carried out with a further 0.15 g of Vazo 67® in solution in 5 g of acetone. After 3.5 hours the batch was diluted with 50 g of acetone/special-boiling-point spirit 60/95 (1:1), after 4.5 hours with 50 g of acetone, after 6.5 hours with 70 g of acetone/special-boiling-point spirit 60/95 (1:1) and after 7.5 hours with 50 g of acetone. After a reaction time of 24 hours the polymerization was terminated by cooling and the product was diluted down to 30% by adding special-boiling-point spirit 60/95.

Gel permeation chromatography (Test A) against polystyrene standards gave Mₙ=112 000 g/mol and M_{w}=237 000 g/mol.

### Example 2

In a second step, 84 g of polystyrene PS were mixed, in a reactor conventional for free-radical polymerizations, with 93 g of stearyl acrylate, 173 g of 2-ethylhexyl acrylate and 100 g of acetone/special-boiling-point spirit 60/95 (1:1). After half an hour of inertization under nitrogen gas, the mixture was heated to an internal temperature of 60° C. and initiation was carried out with 0.15 g of Vazo 67® (DuPont) in solution in 5 g of acetone. After a reaction time of 1.5 hours initiation was carried out with a further 0.15 g of Vazo 67® in solution in 5 g of acetone. After a reaction time of 4 hours initiation was carried out with a further 0.15 g of Vazo 67® in solution in 5 g of acetone. After a reaction time of 5 hours initiation was carried out with a further 0.2 g Vazo 67® in solution in 5 gg of acetone. After 7 and 8 hours dilution was carried out in each case with 100 g of acetone/special-boiling-point spirit, 60/95 (1:1). The polymerization was terminated after a reaction time of 30 hours by cooling and the product was diluted down to 30% by adding special-boiling point spirit 60/95.

Gel permeation chromatography (Test A) against polystyrene standards gave Mₙ=87 000 g/mol and M_{w}=166 000 g/mol. For further use the polymer was stained with a red food dye.

### Example 3

A 2 l reactor conventional for free-radical polymerization was charged under a nitrogen atmosphere with 40 g of acrylic acid, 40 9 of 2-ethylhexyl acrylate, 1.2 g of bis-2,2′-phenylethyl trithiocarbonate regulator and 80 g of acetone. This initial charge was heated to an internal temperature of 60° C. and initiation was carried out with 0.2 g of Vazo 67® (DuPont) in solution in 5 g of acetone. After a reaction time of 1.5 hours initiation was repeated with 0.2 g of Vazo67® (DuPont) in solution in 5 g of acetone. After a reaction time of 5 hours and 7 hours dilution was carried out in each case with 50 g of acetone.

After a reaction time of 24 hours a sample was taken.

Gel permeation chromatography (Test A) against polystyrene standards gave Mₙ=30 100 g/mol and M_{w}=35 300 g/mol.

The polymerization was continued in the same reactor after a reaction time of 24 h. 320 g of 2-ethylhexyl acrylate, 80 g of acetone and 20 g of isopropanol were added to the polymer. After a reaction time of 24.75 hours initiation was repeated with 0.2 g of Vazo 67® (DuPont) in solution in 5 g of acetone. After 28.5 hours and 32 hours dilution was carried out in each case with 50 g of acetone. After 48 hours initiation was repeated with 0.2 g of Vazo 67® (DuPont) in solution in 5 g of acetone. After 55.5 hours 20 g of acetone were added and after 72 hours the reaction was terminated by cooling to room temperature.

Gel permeation chromatography (Test A) against polystyrene standards gave Mₙ=41 900 g/mol and M_{w}=77 400 g/mol.

### Example 4

In a second step, 118 g of polystyrene PS were mixed, in a reactor conventional for free-radical polymerizations, with 34 g of staryl acrylate, 143 g of 2-ethylhexyl acrylate and 100 g of acetone/special-boiling-point spirit 60/95 (1:2). After half an hour of inertization under nitrogen gas, the mixture was heated to an internal temperature of 60° C. and initiation was carried out with 0.15 g of Vazo 67® (DuPont) in solution in 5 9 of acetone. After a reaction time of 1.5 hours initiation was carried out with a further 0.15 g of Vazo 67® in solution in 5 g of acetone. After 3.5 hours the batch was diluted with 50 g of acetone/special-boiling-point spirit 60/95 (1:2), after 4.5 hours with 50 g of acetone, after 6.5 hours with 70 g of acetone/special-boiling-point spirit 60/95 (1:2) and after 7.5 hours with 50 g of acetone. After a reaction time of 24 hours initiation was repeated with 0.15 g of Vazo 67® (DuPont) in solution in 5 g in acetone. The polymerization was terminated after 48 hours by cooling and the product was diluted down to 30% by adding special-boiling-point spirit 60/95.

Gel permeation chromatography (Test A) against polystyrene standards gave Mₙ=72 000 g/mol and M_{w}=143 000 g/mol.

Preparation of Hotmelts:

Examples 1 to 4 were concentrated in a vacuum drying cabinet at 60° C. and 10 torr and freed from their solvent.

Production of Pressure-Sensitive Adhesive (PSA) Pads:

a) Example 1 was coated on a Pröls coating unit at a temperature of 170° C. and a coating speed of 10 m/min, with a melt die, under a pressure of 6 bar and at a rate of 250 g/m² onto a release paper coated with 1.5 g/m² polysiloxane. The polymer coated onto the release paper was subsequently coated onto both sides of a Saran-primed PET film 25 μm thick. Thereafter both polymer surfaces were in turn laminated with Saran-primed PET film 25 μm thick, which had in turn been coated with the polymer. Finally the laminate was lined with release paper and the PSA pads were punched out with a circular blank. The PSA pad produced in this way with various stabilizing films was easy to use to bond paper to various plastics.

b) Exemplary sample 2 was coated on a Prols coating unit at a temperature of 180° C. and a coating speed of 10 m/min, with a melt die, under a pressure of 6 bar and at a rate of 1000 g/m², onto a release paper coated with 1.5 g/m² polysiloxane. The open polymer side was subsequently lined with the same release paper and the PSA pads were punched out with a circular blank.

Production of PSA Mouldings:

Exemplary samples 3 and 4 were melted at 220° C. in a melt cartridge and subsequently poured into a heart-shaped mould. To detach the PSA mouldings from the mould they were cooled to −20° C.

To determine the pressure-sensitive adhesion the pads and PSA mouldings were applied to various test plates (see Test B). All specimens described possessed a sufficiently high pressure-sensitive adhesion to hold their own weight.

1. Moulding comprised of one or more block copolymers based on polyacrylate or mixtures comprising such block copolymers, characterized by inherent pressure-sensitive adhesion properties.

2. Moulding according to claim 1, wherein the mouldings have a sufficiently high pressure-sensitive adhesion to hold their own weight for at least 30 minutes on at least one material selected from polyethylene, ABS (acrylonitrile-butadiene-styrene copolymers) and/or polystyrene when having been pressed onto a sample surface of said material with an applied pressure of 19.6 N/cm².

3. Moulding according to claim 1, wherein the block copolymers have a sequence of at least one polymer block or copolymer block P_{H} having a glass transition temperature of not more than 10° C. and of at least one polymer block or copolymer block P_{S} having a glass transition temperature of at least 20° C.

4. Moulding according to claim 3, wherein the block copolymers comprise at least one triblock structure of the form P_{S}-P_{H}-P_{S} and/or P_{H}-P_{S}-P_{H}.

5. Moulding according to claim 1, wherein the block copolymers comprise at least one functional group which behaves inertly in a free-radical polymerization reaction and which is capable of promoting a crosslinking reaction of the polymers.

6. A method of producing the mouldings of claim 1, which comprises producing said mouldings by diecutting, by compression moulding or by injection moulding.

7. A method for single-sided or double-sided adhesive bonding of substrates, which comprises bonding said substrates with a moulding of claim 1, 2, 3 or 4.

8. A sealing material comprising a moulding of claim 1.
